(19) United States
(12) Patent Application Publication
(10) Pub. No.: US 2025/0376338 A1
(43) Pub. Date: Dec. 11, 2025

(54) APPARATUS FOR THE ALIGNMENT AND ORIENTATION OF PLASTIC PREFORMS

(71) Applicant: ACMI BEVERAGE S.P.A., Sorbolo (Parma) (IT)

(72) Inventor: Mirco MASSARI, Parma (IT)

(21) Appl. No.: 18/869,705

(22) PCT Filed: May 22, 2023
(86) PCT No.: PCT/IB2023/055229

§ 371 Date: Nov. 26, 2024

(30) Foreign Application Priority Data
May 26, 2022 (IT) 102022000011009

(51) Int. Cl. B65G 47/14; B29C 31/00; B29C 49/42; B29L 31/00; B65G 47/52; B65G 47/68; B65G 47/84

(52) U.S. Cl. CPC B65G 47/1492; B29C 31/008; B29C 49/42101; B65G 47/525; B65G 47/68; B65G 47/846; B29L 2031/712; B65G 2047/685; B65G 2811/095

(57) ABSTRACT

An apparatus for the orientation and alignment of plastic preforms provided with collars having greater dimensions than the preform body, includes a device for feeding the preforms at a first end of an unloading and conveyance surface that includes a conveyor device for conveying the preforms from the first end towards a second end, the conveyor device includes a slot formed by a pair of longitudinal movement bodies which move the preforms along a direction of longitudinal extension of the slot. The conveyor device includes at least one conveyor element which forms a resting surface for the preforms and is adapted to move the preforms arranged on the resting surface along a movement direction, which is opposite to the conveyance direction, in order to move the preforms not received by the slot from the second end toward the first end.

### CROSS-REFERENCE TO RELATED APPLICATIONS

This application is a 35 U.S.C. § 371 National Stage patent application of PCT/IB2023/055229, filed on 22 May 2023, which claims the benefit of Italian patent application 102022000011009, filed on 26 May 2022, the disclosures of which are incorporated herein by reference in their entirety.

### TECHNICAL FIELD

The present disclosure relates to an apparatus for the alignment and orientation of plastic preforms for the production of plastic containers.

### BACKGROUND

Various types of apparatus for the alignment and orientation of preforms are known.

A first known type provides for an inclined device provided with a row of receptacles arranged along the perimeter of the machine and intended to accommodate a respective preform (loaded in bulk). By turning the inclined device, each receptacle brings the preform at a first slot, which has a transverse dimension that is smaller than the collar (or ring) of the preform but is sufficient to allow the preform, by rotating, to position itself vertically; the preform then reaches a second slot, which has a transverse dimension that is greater than the collar, so that the preform can freely slide below the device in order to reach an inclined guiding ramp designed to feed it toward the blow molding machine.

A second type of alignment device is constituted by a hopper, which forms internally a concentric ring having a plurality of seats designed to accommodate a respective preform; the hopper is inclined so that the bulk preforms remain in the lower part, while they are arranged in the seats as they ascend.

A device for sorting and orienting plastic preforms provided with collars having greater dimensions than the body of the preform and having a hopper constituted by a base and vertical containment walls is known from European Patent Application EP2079651. Inside the hopper there is an annular element, which rotates about an axis of rotation and is provided with two or more rows of compartments arranged along corresponding concentric circumferences, and an annular object resting surface which extends along an angular portion below the annular element and is interrupted at the defined exit point of the preforms.

Other types of apparatus are known, for example, which utilize the action of centrifugal force as described in U.S. Pat. No. 7,975,852 in the name of Sidel, or in U.S. Pat. No. 8,985,308 in the name of Krones.

### SUMMARY

The aim of the present disclosure is to provide an apparatus for the alignment and orientation of preforms for the production of plastic containers that is capable of improving the background art in one or more of the above aspects.

Within this aim, the disclosure provides an apparatus for the alignment and orientation of preforms for the production of plastic containers that is extremely simple from the constructive standpoint as well as reliable in its operation.

Not least of the disclosure is to provide an apparatus for the alignment and orientation of preforms for the production of plastic containers that is highly reliable, relatively easy to provide, and at competitive costs.

This aim, as well as these and other advantages that will become better apparent hereinafter, are achieved by providing an apparatus for the alignment and orientation of preforms for the production of plastic containers, according to claim 1, optionally having one or more of the characteristics of the dependent claims.

### BRIEF DESCRIPTION OF THE DRAWINGS

Further characteristics and advantages of the disclosure will become better apparent from the description of preferred but not exclusive embodiments of the apparatus for the alignment and orientation of preforms for the production of plastic containers according to the disclosure, illustrated by way of non-limiting example in the accompanying drawings, wherein:

FIG. 1 is a perspective view of a first embodiment of an apparatus for the orientation and alignment of preforms according to the disclosure;

FIG. 2 is a top view of the apparatus of FIG. 1;

FIG. 3 is an enlarged-scale view of a portion of the apparatus in the view of FIG. 2;

FIG. 4 is a front view of the transfer belt;

FIG. 5 is a side view of a portion of the transfer belt;

FIG. 6 is a top view of a portion of the transfer belt;

FIG. 7 is a top view of a second embodiment of the apparatus according to the disclosure;

FIG. 8 is a side view of the apparatus of FIG. 7;

FIG. 9 is a sectional view of the apparatus, taken along the plane of arrangement identified by the lines IX-IX of FIG. 8;

FIG. 10 is a sectional view of the apparatus, taken along the plane of arrangement identified by the lines X-X of FIG. 8;

FIG. 11 is a sectional view of the apparatus, taken along the plane of arrangement identified by the lines XI-XI of FIG. 8; and

FIG. 12 is a schematic view of a preform processing system provided with the apparatus according to the disclosure.

### DETAILED DESCRIPTION OF THE DRAWINGS

With reference to the figures, the apparatus for the orientation and alignment of preforms 10 according to the disclosure, generally designated by the reference numeral 1, comprises a supporting structure 1a constituted for example by a footing connected to supporting posts.

The preforms 10 comprise plastic preforms provided with collars 11 with dimensions that are larger than the preform body 12.

The apparatus 1 comprises a device 90 for feeding the preforms 10 in bulk substantially at a first end 2a of an unloading and conveyance surface 2 delimited laterally by containment walls 2c.

The unloading and conveyance surface 2 comprises a conveyor device 3 for conveying along a conveyance direction 100 the preforms 10 from the first end 2a toward the second end 2b, which is opposite to the first end 2a, of the unloading and conveyance surface 2.

The conveyor device 3 comprises a slot 5 defined by a pair of longitudinal movement bodies 6a, 6b adapted to move the preforms 10 along the direction of extension of the slot 5, from the first end 2a toward the second end 2b.

The slot 5 has a transverse dimension that is greater than the dimension of the preform body 12 and smaller than the dimension of the collar 11 of the preforms 10 in order to receive at least one part of the preforms 10 in a condition in which they hang by said collar 11.

The conveyor device 3 comprises at least one conveyor element 4a, 4b, etc., which is arranged laterally and parallel to the pair of longitudinal movement bodies 6a, 6b and defines a resting surface for the preforms 10.

At least one conveyor element 4a, 4b, etc., is adapted to move the preforms arranged on the resting surface along a movement direction, indicated by the arrow 101, which is opposite to the conveyance direction, indicated by the arrow 100, to move the preforms 10 not received or expelled from the slot 5 from the second end 2b toward the first end 2a.

Advantageously, at least one conveyor element 4a, 4b, etc. is arranged, for at least one portion thereof, adjacent to one of the longitudinal movement bodies 6a.

The conveyor device 3 includes at least one recirculation body 11a, which is arranged laterally adjacent to said at least one conveyor element 4a, 4b, and arranged on the opposite side with respect to the pair of longitudinal movement bodies 6a, 6b.

The recirculation body 11a is adapted to move the preforms arranged on the respective resting surface 4c along a direction 100′ which is parallel to the conveyance direction 100.

Advantageously, the unloading and conveyance surface 2 is associated, at the first end 2a, with a feeder device 7, which is adapted to send the preforms 10 unloaded in bulk toward the conveyor device 3.

Preferably, above the slot 5 there is a device 30 for removing the improperly seated preforms 10.

Moreover, the apparatus 1 is provided with actuation means adapted to adjust the advancement speed of said conveyor elements 4a, 4b, etc. and possibly of the recirculation body 11a.

According to a preferred practical embodiment, the longitudinal movement bodies 6a, 6b comprise a respective motorized belt or chain.

By way of example, the feeder device 7 can comprise a conveyor belt or ribbon associated with movement means.

The removal device may provide for the use of spatulas 91 or brushes designed to affect portions of preforms 10 if the latter are not properly seat within the slot 5.

Nothing prohibits the removal device from comprising jets of compressed air.

The advancement speed of the longitudinal movement bodies 6a, 6b can be the same, or the two advancement speeds 25 can be different to facilitate the insertion of the body of the preform 12 inside the slot 5.

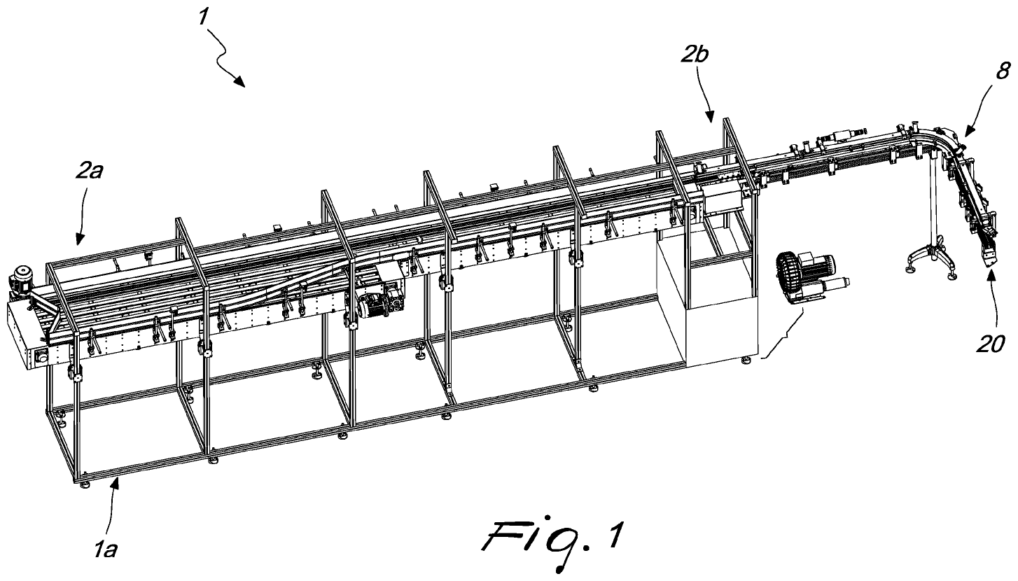

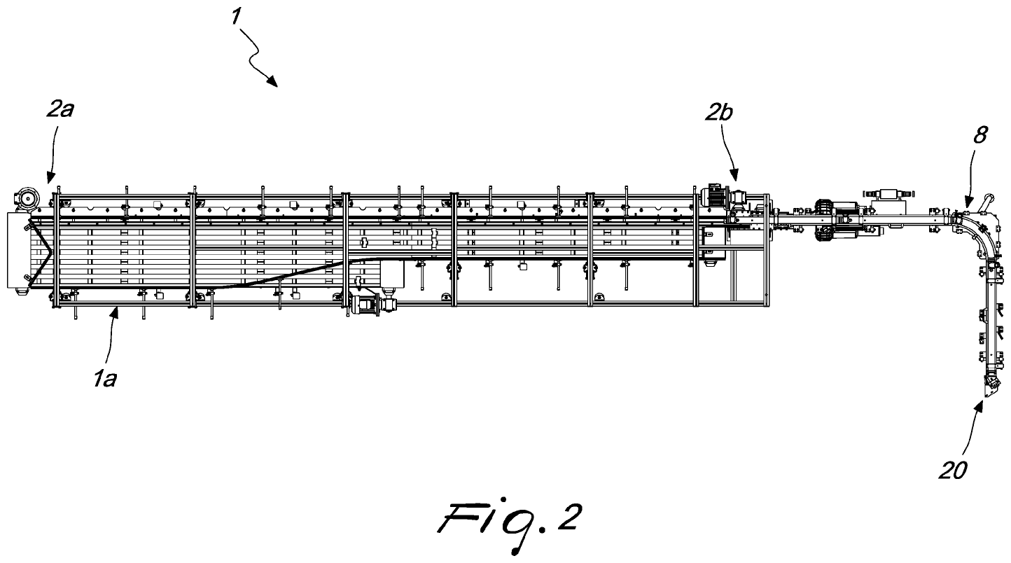

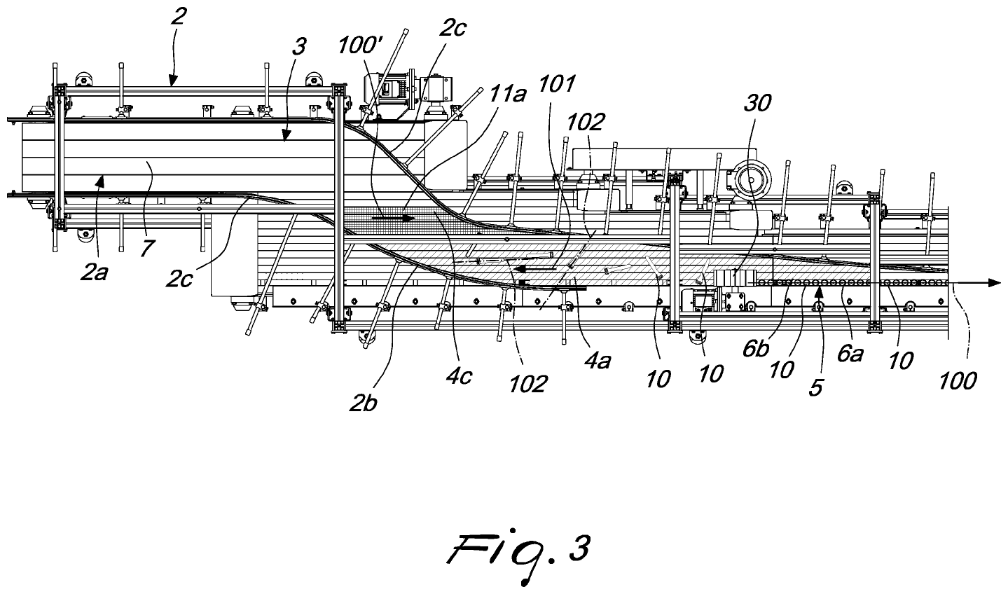

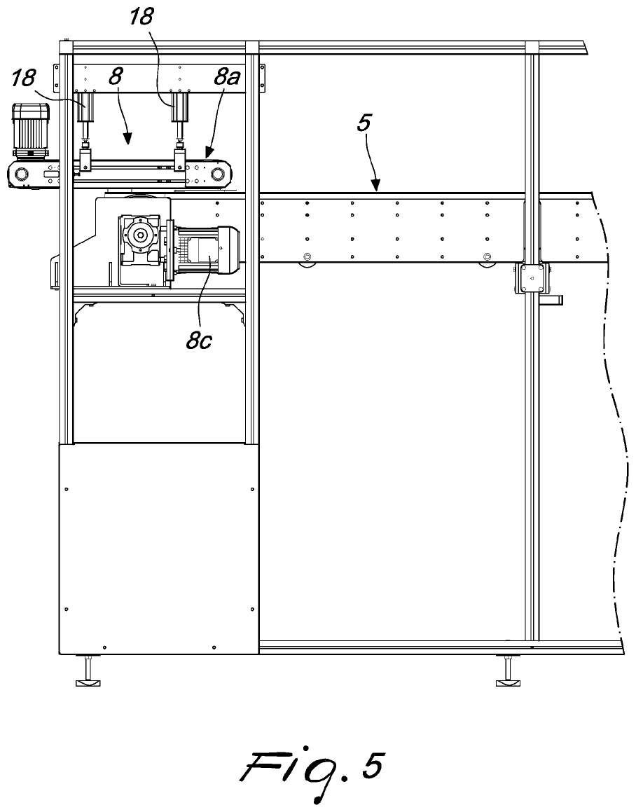

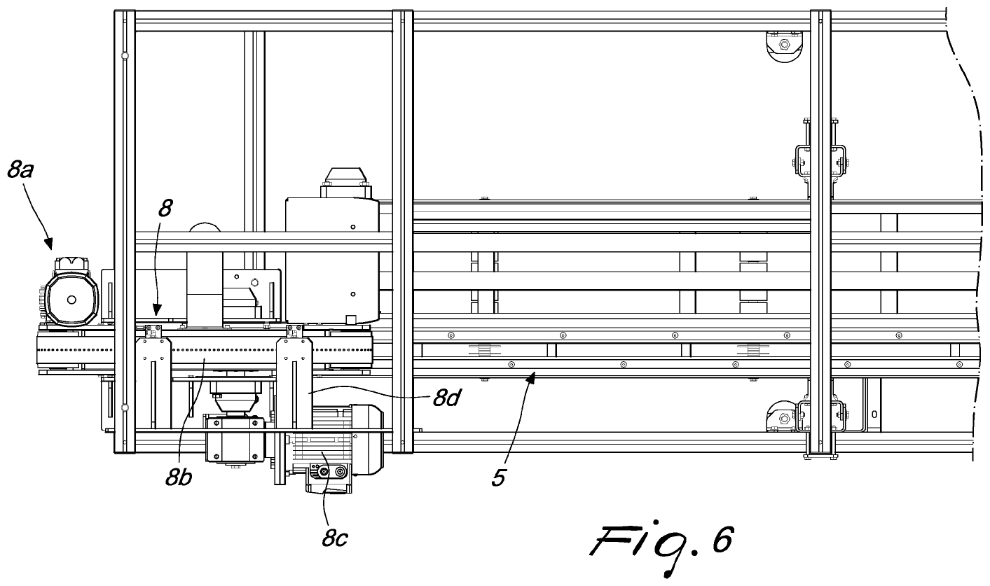

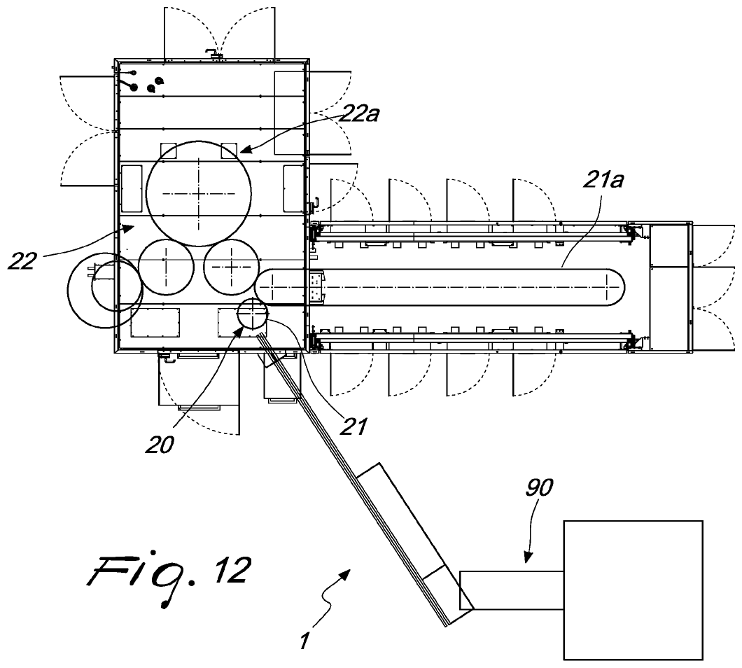

With reference to the first embodiment shown in FIGS. 1 to 6, the slot 5 leads to a transfer belt 8 designed to feed the preforms 10, oriented and aligned, to a feeder element 20, leading for example into a star conveyor 21 for feeding to a blow molding apparatus 22 (shown in FIG. 12).

In particular, the feeding star conveyor 21 is functionally associated with a conditioning oven 21a, arranged upstream of a blower 22a.

The conveyor device 3 defines a substantially horizontal plane of arrangement.

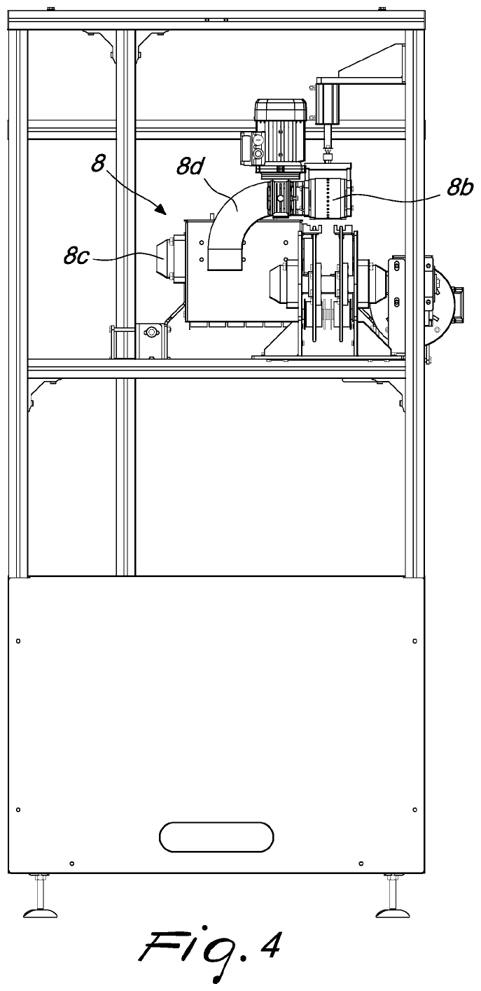

With reference to what is shown in FIGS. 4 to 6, the transfer belt 8 comprises a suction ribbon belt 8a configured to transfer the preforms toward the feeder element 20.

The suction ribbon belt 8a conveniently comprises a perforated ribbon 8b, which is movable on command, by virtue of a movement motor, along the direction of extension of the transfer belt 8.

The perforated ribbon 8b is functionally associated with at least one suction unit 8c connected to a suction tube 8d adapted to provide a partial vacuum at the downward-facing surface of the perforated ribbon 8b so as to retain the preforms, in a condition in which they hang, during movement along the transfer guide 8.

The conveyor device 2 is furthermore associated with a jamming prevention device 18.

The jamming prevention device is advantageously arranged at the passage region between the longitudinal movement bodies 6a, 6b and the suction ribbon belt 8a.

This, in fact, is a critical region where a problem may arise should a preform 10 arrive in an incorrect position.

Conveniently, the jamming prevention device 18 comprises means for the movement of the suction ribbon belt 8a which are configured to move the suction ribbon belt 8a on command substantially along a vertical direction.

Preferably, the movement means comprise one or more pneumatic cylinders functionally connected to sensor means, for example of the photocell-based type, adapted to detect the sliding of the preforms at the suction ribbon belt 8a, by means of a photocell.

If the sensor means do not detect the sliding of the preforms 5 along the suction ribbon belt 8a, the movement means are operated and lift the suction ribbon belt 8a so that the jammed preforms are unloaded. The suction ribbon belt 8a is then lowered again and the system resumes normal operation.

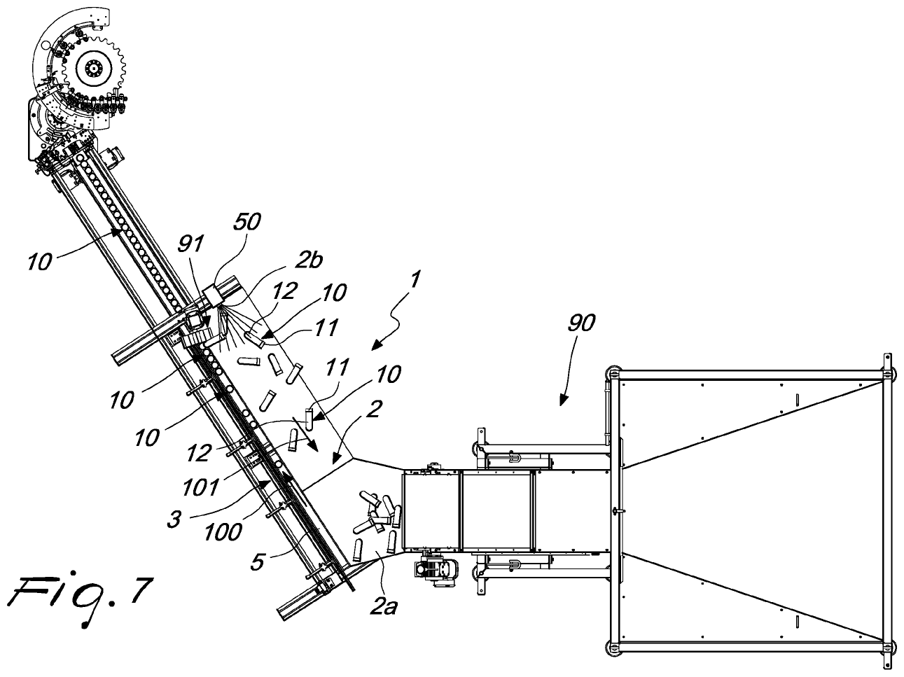

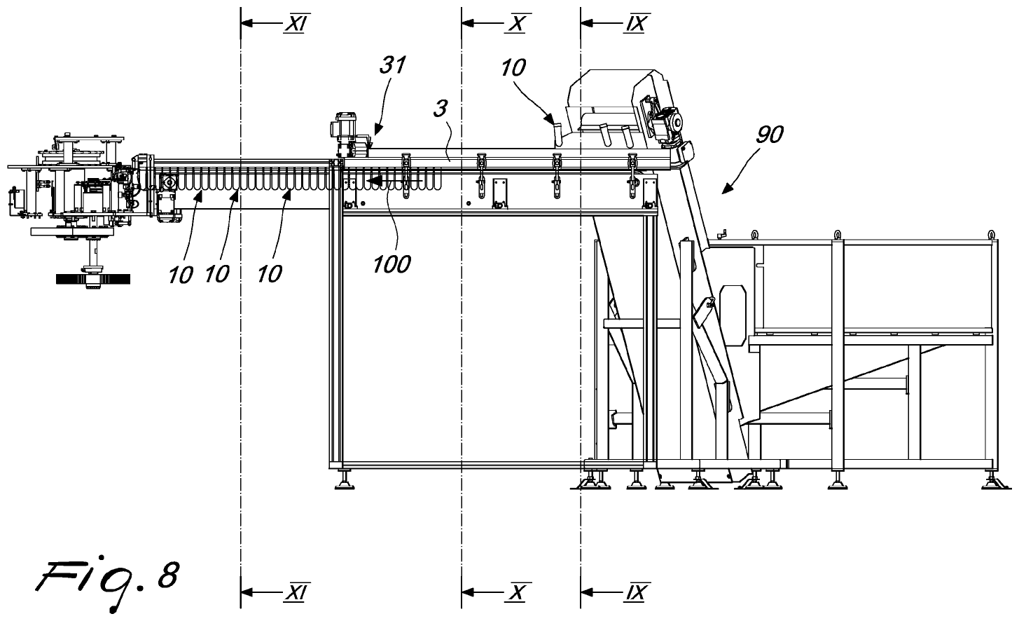

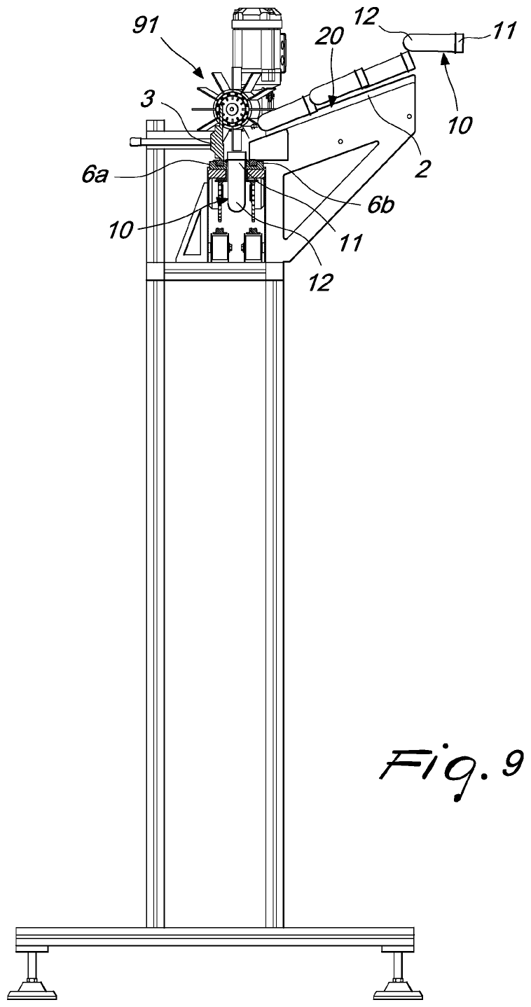

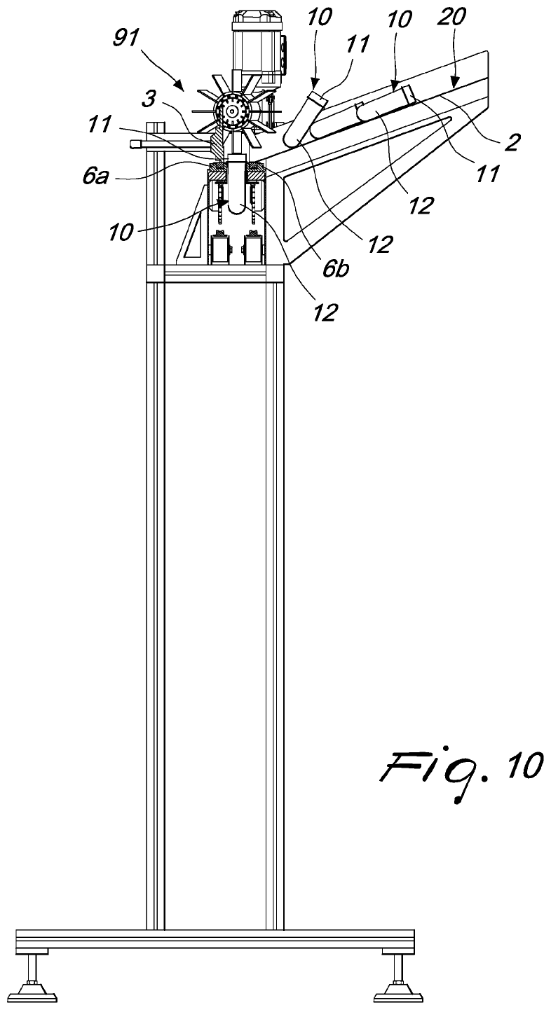

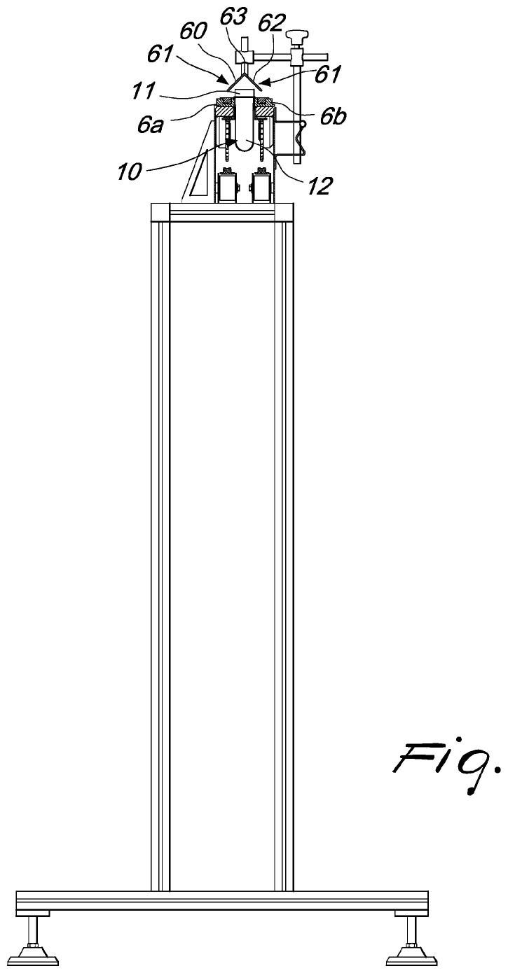

With reference to the second embodiment shown in FIGS. 7 to 11, the apparatus 1 has the conveyor element 4a, 4b, etc. which comprises an inclined recirculation surface 20 that extends so as to rise along the direction away from the slot 5, and pusher means 51 adapted to move the preforms 10 arranged on the inclined recirculation surface 20 along a movement direction 101, opposite to the conveyance direction 100, in order to move the preforms 10 not received by the slot 5 from the second end 2b toward the first end 2a.

Preferably, the pusher means 50 comprise at least one device for emitting an air jet.

Advantageously, the slot 5 is connected, at the first end 2a, to a guiding portion which extends along at least one direction of extension having a substantially vertical component.

In particular, the guiding portion comprises, in sequence, at least one first guiding portion which extends along a substantially vertical direction and at least one portion for connection between the at least one first guiding portion and the slot 5.

Conveniently, the apparatus 1 comprises, downstream of any selection elements such as, for example, vanes and/or air blowers, above the longitudinal movement bodies 6a, 6b, a retention guide 60 having at least two lateral portions 61 configured to delimit in an upward region the movement of the preforms 10 during their movement along the conveyance direction 100.

The apparatus 1 comprises, for example, a longitudinal element 62 with two inclined surface which forms, on opposite sides with respect to its apex 63, the lateral portions 61.

Conveniently, the longitudinal movement bodies 6a, 6b lead directly at a straight feeding portion line of a feeding star conveyor 20. The operation of the apparatus 1 for the orientation and alignment of preforms 10 made of plastic, according to the disclosure, is as follows.

The preforms 10 are unloaded, in bulk, at the first end 2a of the unloading and conveyance surface 2.

From there, possibly by virtue of the action of the feeder device 7, the preforms 10 arrive at the slot 5, which conveys them toward the second end 2b of the unloading and conveyance surface 2.

By virtue of the action of the conveyor element 4a, the preforms 10 that are not properly accommodated within the slot 5, or that are expelled from it, are returned to the first end 2a so that they can be positioned in the slot 5.

In practice it has been found that the disclosure achieves the intended aim and advantages, providing an apparatus 1 for the orientation and alignment of preforms 10 that is extremely practical and efficient.

In particular, with reference to the embodiment shown in FIGS. 7 to 11, it has been possible to reduce significantly the longitudinal extension of the apparatus, thus allowing the packing of the preforms 10 directly along the extension of the longitudinal movement bodies 6a, 6b.

In this way, it is possible to “enter” directly at the oven region without the need to provide an intermediate conveyor.

The provision of the retention guide 60 arranged above the longitudinal movement bodies 6a, 6b and configured like a roof tile furthermore prevents the preforms 10 under pressure from rising upward. Moreover, the shape of the retention guide 60 allows the preforms 10 that are not yet perfectly vertical to properly align in transport.

Finally, the provision, at the first end 2a, of the guiding portion that extends along at least one direction of extension, helps the preforms, during their fall, to be pre-oriented before reaching the longitudinal movement bodies 6a, 6b.

Moreover, it is possible to provide devices for generating blasts of air, advantageously compressed air, which, in case of jamming of the apparatus 1, for example due to excessive accumulation of preforms 10, are configured to blow at the accumulation region to unjam it and automatically restart the machine.

The disclosure thus conceived is susceptible of numerous modifications and variations, all of which are within the scope of the accompanying claims; all the details may furthermore be replaced with other technically equivalent elements.

In practice, the materials used, so long as they are compatible with the specific use, as well as the contingent shapes and dimensions, may be any according to the requirements and the state of the art,

1-17. (canceled)

18. An apparatus for the orientation and alignment of plastic preforms provided with collars having greater dimensions than a preform body, comprising a device for feeding the preforms in bulk substantially at a first end of an unloading and conveyance surface which is delimited laterally by containment walls, said unloading and conveyance surface comprising a conveyor device for conveying said preforms from said first end towards a second end, which is opposite to said first end, of said unloading and conveyance surface, said conveyor device comprising a slot which is formed by a pair of longitudinal movement bodies which are configured to move said preforms along a conveyance direction defined by said slot from said first end toward said second end, said slot having a transverse dimension that is greater than a dimension of said preform body and is smaller than a dimension of said collar of said preforms in order to receive at least part of said preforms in a condition in which said preforms hang by said collar, said conveyor device comprising at least one conveyor element which is arranged laterally and parallel to said pair of longitudinal movement bodies and forms a resting surface for said preforms, said at least one conveyor element being configured to move the preforms arranged on said resting surface along a movement direction, which is opposite to said conveyance direction, in order to move the preforms not received by said slot from said second end toward said first end.

19. The apparatus according to claim 18, wherein said at least one conveyor element is arranged, for at least a portion thereof, adjacent to one of said longitudinal movement bodies.

20. The apparatus according to claim 18, wherein said longitudinal movement bodies comprise a respective motorized chain or belt.

21. The apparatus according to claim 18, wherein said conveyor element comprises an inclined recirculation surface which extends so as to rise along a direction away from said slot, and pusher means configured to move the preforms arranged on said inclined recirculation surface along a movement direction, which is opposite with respect to said conveyance direction, in order to move the preforms not received by said slot from said second end toward said first end.

22. The apparatus according to claim 21, wherein said pusher means comprise at least one device for emitting a jet of air.

23. The apparatus according to claim 18, wherein said slot is connected, at the first end, to a guiding portion which extends along at least one direction of extension which has a substantially vertical component.

24. The apparatus according to claim 23, wherein said guiding portion comprises, in sequence, at least one first guiding portion which extends along a substantially vertical direction and at least one portion for connection between said at least one first guiding portion and said slot.

25. The apparatus according to claim 18, further comprising at least one recirculation body which is arranged laterally adjacent to said at least one conveyor element and is arranged opposite to said pair of longitudinal movement bodies, said at least one recirculation body being configured to move the preforms arranged on the respective resting surface along a direction which is substantially parallel to said conveyance direction.

26. The apparatus according to claim 18, wherein said conveyor device has, at said first end, a feeder device which is configured to send said preforms unloaded in bulk toward said conveyor elements.

27. The apparatus according to claim 18, further comprising, above said slot, a device for removing the preforms that are not properly accommodated.

28. The apparatus according to claim 18, further comprising actuation means which are configured to adjust an advancement speed of said conveyor elements.

29. The apparatus according to claim 18, further comprising, above said longitudinal movement bodies, a retention guide provided with at least two lateral portions which are configured to delimit in an upper region a displacement of the preforms during movement of said preforms along said conveyance direction.

30. The apparatus according to claim 29, further comprising a longitudinal element with two inclined surfaces which forms, on opposite sides with respect to an apex thereof, said at least two lateral portions.

31. The apparatus according to claim 18, wherein said longitudinal movement bodies lead directly at a rectilinear feeding portion of a feeding star conveyor.

32. The apparatus according to claim 18, wherein said slot leads to a transfer belt that is designed to feed oriented and aligned preforms to a feeder element, said transfer belt comprising a suction ribbon belt configured to transfer said oriented and aligned preforms toward said feeder element.

33. The apparatus according to claim 32, wherein said suction ribbon belt comprises a perforated ribbon configured to move on command, by means of a movement motor, along a direction of extension of said transfer guide, said perforated ribbon being functionally associated with at least one suction unit which is connected to a suction tube adapted to provide a partial vacuum at a surface of the perforated ribbon that is directed downward so as to retain, hanging, the preforms during movement along said transfer guide.

34. The apparatus according to claim 32, wherein said conveyor device is associated with a jamming prevention device arranged at a passage region between said longitudinal movement bodies and said suction ribbon belt, said jamming prevention means comprising means for a movement of said suction ribbon belt which are configured to move said suction ribbon belt on command substantially along a vertical direction.
